(19) United States
(12) Patent Application Publication
(10) Pub. No.: US 2013/0161958 A1
(43) Pub. Date: Jun. 27, 2013

(54) Dual Stator Permanent Magnet Direct-drive Wind Power Generator with Stationary Shaft Support

(71) Applicants: Shancai Xiao, Beijing (CN); Wenjiang Shi, Beijing (CN); Jingbo Liu, Beijing (CN); Ming Qin, Beijing (CN); Lihong Ma, Beijing (CN)

(72) Inventors: Shancai Xiao, Beijing (CN); Wenjiang Shi, Beijing (CN); Jingbo Liu, Beijing (CN); Ming Qin, Beijing (CN); Lihong Ma, Beijing (CN)

(73) Assignee: GUODIAN UNITED POWER TECHNOLOGY CO., LTD, BEIJING (CN)

(21) Appl. No.: 13/511,146

(22) PCT Filed: Jun. 30, 2011
(86) PCT No.: PCT/CN2011/001080

§ 371 Date: Mar. 5, 2013

(30) Foreign Application Priority Data
May 20, 2011 (CN) 201110131637.0

(51) Int. Cl. F03D 9/00

(52) U.S. Cl. CPC F03D 9/002
USPC 290/55

(57) ABSTRACT

A double-stator permanent magnetic direct-driven wind power generator supported by a fixed shaft (17) includes a wheel hub (1), the fixed shaft, a front bearing (15), shaft sleeves (16), a back bearing (18), a front bearing end cover (2), back bearing positioning elements (19), hollow rotating shafts (3), a rotor disk (5), a rotor (8), an outer stator (7), an inner stator (9), an inner stator bracket (11), a generator front end cover (4), a generator shell (6) and a frame (14). The fixed shaft is connected with the frame; the front bearing and the back bearing are mounted on the fixed shaft; the shaft sleeves are sleeved on the fixed shaft and arranged between inner rings of the front bearing and the back bearing; the back bearing locating elements are arranged outside the back bearing; the hollow rotating shafts are sleeved on the front and back bearings of the fixed shaft; the front bearing end cover is connected with the hollow rotating shafts. The generator reduces weight and cost greatly.

### BACKGROUND OF THE INVENTION

The present invention relates to the field of large scale dual stator permanent magnet direct-drive wind power generator, and specifically relates to a dual stator permanent magnet direct-drive wind power generator with stationary shaft support.

A power generator will grow in size along with its power increase. In particular, a low speed power generator such as a permanent magnet direct-drive wind power generator will become very bulky and causes serious problems to conveyor belts when its power is greater than one or several megawatt (MW). In response to the said problems, a power generator could adopt dual stator structure so that output power per unit volume of the power generator will increase, thereby reducing the size and weight of the power generator. Accordingly, costs are lowered and transportation is easier. However, existing dual stator permanent magnet direct-drive wind power generators mostly adopt a transmission chain design using dual row tapered roller bearings (nautilus bearings), therefore a large and heavy generator cabin shell body mounted at an outer side of the wind power generator has to bear both the great axial thrust and pitching moment load of the wind power generator's hub. Also, dual row tapered roller bearings are very expensive. A large scale dual stator permanent magnet direct-drive wind power generator of the prior arts is heavy in its overall weight and involves higher costs because of using the above structure.

### BRIEF SUMMARY OF THE INVENTION

The present invention provides a dual stator permanent magnet direct-drive wind power generator with stationary shaft support significant in cost reduction and particularly suitable for permanent magnet direct-drive wind power generator with power level of megawatt and above.

The present invention adopts the following technical proposal:

A dual stator permanent magnet direct-drive wind power generator with stationary shaft support comprises a hub, a stationary shaft, a front bearing, a shaft sleeve, a rear bearing, a front bearing end cover, a rear bearing positioning piece, a hollow rotational shaft, a rotor turnplate, a rotor, an outer stator, an inner stator, an inner stator support, a generator front end cover, a generator outer shell and a frame; the stationary shaft is connected with the frame; the front bearing and the rear bearing are mounted on the stationary shaft; the shaft sleeve jackets over the stationary shaft and is disposed between inner rings of the front and rear bearings respectively; the rear bearing positioning piece is provided at an outer side of the rear bearing; the hollow rotational shaft jackets over the front and rear bearings of the stationary shaft; the front bearing end cover is connected with the hollow rotational shaft; the hub is connected with the rotor turnplate and the hollow rotational shaft; the rotor turnplate is connected with a front end of the rotor; the rotor is disposed between the inner stator and the outer stator; the inner stator is mounted on the inner stator support; the inner stator support is connected with the frame; the outer stator is mounted inside the generator outer shell; two ends of the generator outer shell are connected with the generator front end cover and the frame respectively.

A rotor rear support, a rotor rear bearing, a rotor rear bearing support and a rear flange are disposed between the inner stator support and the frame; a rear end of the rotor is connected with the rotor rear support; the rotor rear support is mounted on the rotor rear bearing; the rotor rear bearing is mounted on the rotor rear bearing support; one end of the rotor rear bearing support is connected with the inner stator support and another end of which is connected with the rear flange and the frame; the generator outer shell and the frame are connected with each other via the rear flange.

The front bearing and the rear bearing are self-aligning bearings.

The stationary shaft is a hollow stationary shaft.

An outer side of the frame is mounted with a generator cabin casing with fiber reinforced plastic structure.

The rear bearing positioning piece is a shaft nut or a rear bearing end cover.

The rotor rear bearing is a deep groove ball bearing.

The present invention adopts a dual stator structure in a direct-drive wind power generator and uses a stationary shaft support in a transmission chain. Therefore, apart from characteristics such as large power density, small size and light weight of a dual stator direct-drive wind power generator, the present invention also has the following advantages:

1. By using a stationary shaft support structure during transmission, it is not necessary for the present invention to use dual row tapered roller bearings (nautilus bearings) which are expensive. Instead, self-aligning bearings common to wind power generator set could be used. When comparing the respective total costs of using these two different kinds of bearing in a transmission chain design, it is noted that the total costs of using nautilus bearings are about three times as much as the total costs of using self-aligning bearings. Therefore, the costs of bearings are reduced more significantly by using the proposal of the present invention.

2. By using a stationary shaft to bear and transmit loads of an impeller, it is not necessary to use a large and heavy generator cabin shell body which has to bear loads of a hub. Instead, it is substituted by a generator cabin casing which could adopt a light type fiber reinforced plastic structure, thereby significantly reducing the overall weight of the generator.

3. The present invention uses a hollow stationary shaft to bear and transmit loads of a hub and does not use a heavy type forged main shaft, thereby significantly reducing the weight and costs of a main shaft.

4. The present invention is additionally provided with an ordinary deep groove ball bearing at a rear end of a rotor of the power generator. The bearing could ensure that the rotor and stators are concentric in any operating conditions of the power generator. The present invention could significantly reduce the weight and costs of a direct-drive wind power generator and could be widely applied to direct-drive wind power generating system.

Since the present invention uses a stationary shaft support structure in a transmission chain design of a dual stator wind power generator, it is not necessary to use dual row tapered roller bearings which are expensive. Also, by transmitting loads of a wind power generator's hub directly onto a wind power generator's frame via a hollow stationary shaft which has significantly shorter diameter, overall weight of the generator could be significantly reduced. Use of the above design of the present invention is an effective way to significantly reduce the costs of a permanent magnet direct-drive wind power generator.

### BRIEF DESCRIPTION OF THE DRAWINGS

FIG. 1 illustrates fitting of main components of an overall structure of the present invention.

### DETAILED DESCRIPTION OF THE INVENTION

The present invention is described in detail below with reference to an accompanying drawing and an embodiment.

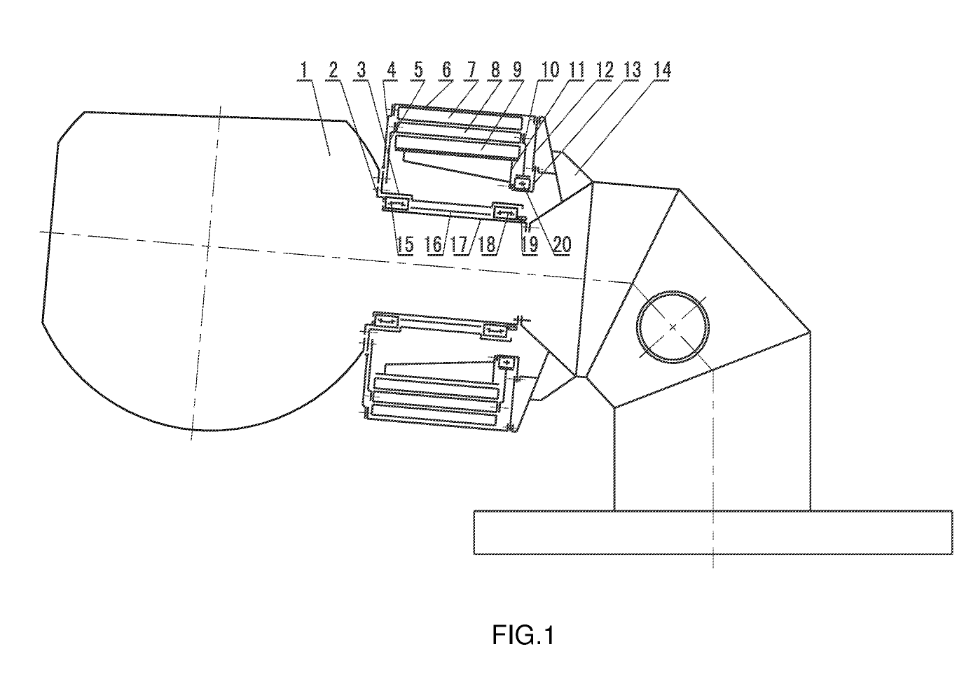

In FIG. 1, short centerlines represent bolts and nuts of various specifications. Other main components of the present invention include: a hub 1, a front bearing end cover 2, a hollow rotational shaft 3, a generator front end cover 4, a rotor turnplate 5, a generator outer shell 6, an outer stator 7, a rotor 8, an inner stator 9, a rotor rear support 10, an inner stator support 11, a rear flange 12, a rotor rear bearing support 13, a frame 14, a front bearing 15, a shaft sleeve 16, a stationary shaft 17, a rear bearing 18, a rear bearing positioning piece (shaft nut) 19, and a rotor rear bearing 20.

The stationary shaft 17 is fixedly connected with the frame 14; the front bearing 15 and the rear bearing 18 are mounted on the stationary shaft 17; the shaft sleeve 16 jackets over the stationary shaft 17 and is disposed between inner rings of the front and rear bearings 15, 18 respectively; the rear bearing positioning piece (shaft nut) 19 is provided at an outer side of the rear bearing 18; the hollow rotational shaft 3 jackets over the front and rear bearings 15, 18 of the stationary shaft 17; the front bearing end cover 2 is fixed on the hollow rotational shaft 3 by bolt.

The hub 1 is fixed with the rotor turnplate 5 and the hollow rotational shaft 3 via stopper flange and bolt; the rotor turnplate 5 is fixedly connected with a front end of the rotor 8; the rotor turnplate 5 is used for transmitting torsion of the hub; the rotor 8 is disposed between the inner stator 9 and the outer stator 7; the inner stator 9 is mounted on the inner stator support 11; the outer stator 7 is mounted inside the generator outer shell 6; a front end of the generator outer shell 6 is connected with the generator front end cover 4; a rear end of the rotor 8 is fixedly connected with the rotor rear support 10; the rotor rear support 10 is used for ensuring that the rear end of the rotor 8 and the stators are concentric; the rotor rear support 10 is mounted on the rotor rear bearing 20; the rotor rear bearing 20 is mounted on the rotor rear bearing support 13; one end of the rotor rear bearing support 13 is connected with the inner stator support 11 and another end of which is fixedly connected with the rear flange 12 and the frame 14; the rear flange 12 is fixed with a rear end of the generator outer shell 6 and also the frame 14.

In the above embodiment, the front bearing 15 and the rear bearing 18 could be self-aligning bearings; the stationary shaft 17 could be a hollow stationary shaft; the rotor rear bearing 20 could be an ordinary deep groove ball bearing; the rear bearing positioning piece 19 could also be replaced by a rear bearing end cover; an outer side of the frame 14 could also be mounted with a generator cabin casing with fiber reinforced plastic structure (not shown in the figure).

The above description is only a preferred embodiment of the present invention and does not serve to limit the present invention. Even though a detailed description of the present invention is disclosed with reference to the above embodiment, a person skilled in the art could still make changes to the technical proposal described in the above embodiment or make equivalent replacements of part of the technical features thereof. Any changes, equivalent replacements and modifications etc. within the spirit and principle of the present invention should fall within the scope of protection of the present invention.

What is claimed is:

1. A dual stator permanent magnet direct-drive wind power generator with stationary shaft support, characterized in that it comprises a hub, a stationary shaft, a front bearing, a shaft sleeve, a rear bearing, a front bearing end cover, a rear bearing positioning piece, a hollow rotational shaft, a rotor turnplate, a rotor, an outer stator, an inner stator, an inner stator support, a generator front end cover, a generator outer shell and a frame;
the stationary shaft is connected with the frame; the front bearing and the rear bearing are mounted on the stationary shaft; the shaft sleeve jackets over the stationary shaft and is disposed between inner rings of the front and rear bearings respectively; the rear bearing positioning piece is provided at an outer side of the rear bearing; the hollow rotational shaft jackets over the front and rear bearings of the stationary shaft; the front bearing end cover is connected with the hollow rotational shaft;
the hub is connected with the rotor turnplate and the hollow rotational shaft;
the rotor turnplate is connected with a front end of the rotor; the rotor is disposed between the inner stator and the outer stator; the inner stator is mounted on the inner stator support; the inner stator support is connected with the frame; the outer stator is mounted inside the generator outer shell;
two ends of the generator outer shell are connected with the generator front end cover and the frame respectively.

2. The dual stator permanent magnet direct-drive wind power generator as in claim 1, characterized in that a rotor rear support, a rotor rear bearing, a rotor rear bearing support and a rear flange are disposed between the inner stator support and the frame;
a rear end of the rotor is connected with the rotor rear support; the rotor rear support is mounted on the rotor rear bearing; the rotor rear bearing is mounted on the rotor rear bearing support; one end of the rotor rear bearing support is connected with the inner stator support and another end of which is connected with the rear flange and the frame; the generator outer shell and the frame are connected with each other via the rear flange.

3. The dual stator permanent magnet direct-drive wind power generator as in claim 1 or claim 2, characterized in that the front bearing and the rear bearing are self-aligning bearings.

4. The dual stator permanent magnet direct-drive wind power generator as in claim 1 or claim 2, characterized in that the stationary shaft is a hollow stationary shaft.

5. The dual stator permanent magnet direct-drive wind power generator as in claim 1 or claim 2, characterized in that an outer side of the frame is mounted with a generator cabin casing with fiber reinforced plastic structure.

6. The dual stator permanent magnet direct-drive wind power generator as in claim 1 or claim 2, characterized in that the rear bearing positioning piece is a shaft nut or a rear bearing end cover.

7. The dual stator permanent magnet direct-drive wind power generator as in claim 2, characterized in that the rotor rear bearing is a deep groove ball bearing.
